(19) United States
(12) Patent Application Publication
(10) Pub. No.: US 2023/0088058 A1
(43) Pub. Date: Mar. 23, 2023

(54) METHOD AND APPARATUS FOR THE COMPUTER-AIDED COMPLETION OF A 3D PARTIAL MODEL FORMED BY POINTS

(71) Applicant: Siemens Schweiz AG, Zurich (CH)

(72) Inventor: Hermann Georg Mayer, Prien am Chiemsee (DE)

(21) Appl. No.: 17/947,240

(22) Filed: Sep. 19, 2022

(30) Foreign Application Priority Data
Sep. 21, 2021 (EP) 21198054.5

(51) Int. Cl. G06V 20/64; G06V 10/26; G06T 7/68; G06V 10/82; G06V 10/74

(52) U.S. Cl. CPC G06V 20/64; G06V 10/26; G06T 7/68; G06V 10/82; G06V 10/761

(57) ABSTRACT

A method for the computer-aided completion of a 3D partial model—formed by points—of a partial region of an object that is captured by at least one capture device, wherein the 3D partial model can be supplemented with a hidden or missing partial region of the object situated outside the 3D partial model of the object that is to be completed, is provided. The method includes determining a geometry of the object, identifying the hidden or missing partial region of the object on the basis of the determined geometry of the object, supplementing the 3D partial model to form a complete 3D model with the identified hidden or missing partial region of the object, and c) outputting the completed 3D model at an output unit.

### CROSS-REFERENCE TO RELATED APPLICATIONS

This application claims priority to EP Application No. 21198054.5, having a filing date of Sep. 21, 2021, the entire contents of which are hereby incorporated by reference.

### FIELD OF TECHNOLOGY

The following relates to a method and an apparatus for the computer-aided completion of a 3D partial model formed by points, and also to an associated computer program (product).

### BACKGROUND

The increasingly widespread use of inexpensive LiDAR devices (abbreviation of Light imaging, detection and ranging) has made it possible in the meantime for point clouds to be generated and evaluated for a large number of applications. LiDAR is a method related to radar for optical distance and speed measurement and also for remote measurement of atmospheric parameters. It is a form of three-dimensional laser scanning. A point cloud is a set of points of a vector space that has an unorganized spatial structure (“cloud”). A point cloud is described by the points contained, which are each captured by their spatial coordinates.

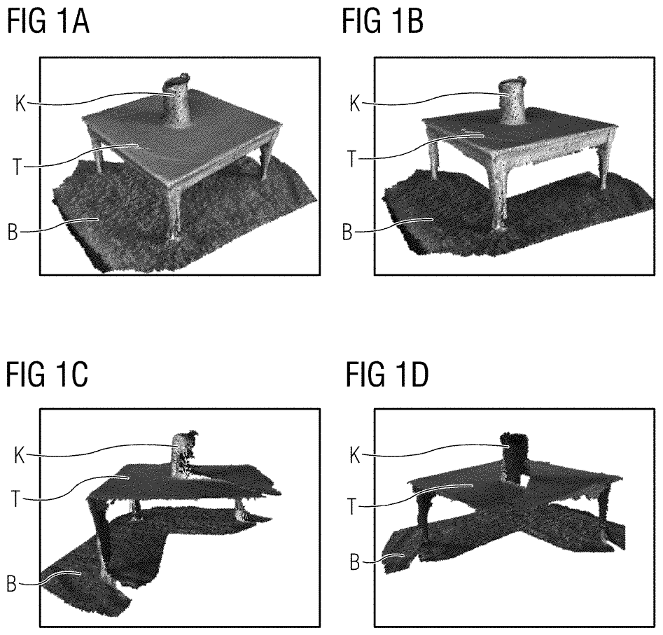

Nowadays point clouds can be generated by mobile devices just as quickly as video films, or it has also become possible in the meantime for anyone themselves to generate simple 3D models of body parts (in particular face/head) (e.g., using the FaceID technology known from the iPhone). However, one disadvantage of this fast, simple generation of point clouds is the incompleteness thereof. In this regard, e.g., when capturing a furnishings scene, only the surfaces which are directly visible from the user are captured. FIG. 1A shows items as a point cloud in an original view. A table T standing on a floor B, with a jug K placed thereon, is depicted there. However, as soon as the point cloud is viewed from a different viewing angle, it appears only incomplete. That is discernible in FIGS. 1B to 1D. FIG. 1B shows the same items with a different view from further “down” if the floor represents the reference plane for a coordinate system and different views. FIG. 1C shows the same items in a view to the right of the original view, and FIG. 1D shows the same items in a view from the opposite side to the original view.

A meshing method can be used to create 3D surfaces, 3D objects and digital terrain models (abbreviated to DTM) or building models (abbreviated to BIM) from the point cloud, and they can be processed further in a CAD system (Computer Aided Design).

Image-based meshing denotes the automated process of creating simplified surface descriptions from three-dimensional image files, without carrying out a prior reconstruction of the surface. Image files that have been created by an imaging system or a capture device, for example, can be converted into a computer model by this method. Creating polygon networks from a three-dimensional image file poses a large number of challenges, but also affords possibilities for making more realistic and more accurate geometric descriptions of the definition ranges. Conversely, point clouds can be generated by models created by meshing.

Besides the purely optical problem of hidden or missing portions, this also makes it more difficult to calculate surface areas, masses and volume, if e.g., the intention is to use fast camera capture or scans to estimate how much free space in an office is still available for further furnishing, or which areas/surfaces have to be cleaned. As a further example, the individual production of items or medical aids would be conceivable (e.g., partial scan of the head for fitting spectacles/helmets or scan of the hand for fitting an individual hand splint). In this case, too, a user can hardly accomplish a complete scan of the respective body part while the user is himself/herself operating the device.

An aim, therefore, is to complete the scanned scene or the scanned object if possible, in order to improve the visual impression of the scene and also to enable simple surface area and volume estimations.

In order that all surfaces are present or closed during 3D scans, it is possible to move around individual objects completely using the capture or recording device or to move the objects themselves (e.g., on a turntable) while the recording device is stationary. This is necessary in the case of purely image-based reconstruction methods without LiDAR technology. This procedure is not very practicable and is time-consuming, however, particularly when scanning rooms. In order e.g., to capture the furnishings correctly, it would be necessary to scan around every chair and behind/under every table in order to completely image these items of furniture. This is not possible with certain devices (e.g., stationary scanners or mobile scanners).

A further possibility for extending the scene by additional information consists in replacing parts of the point cloud with known objects that are already known to the device (3D object recognition). However, this functions only if the point cloud has a sufficiently high quality—in particular, the point cloud of the scanned object should be present substantially completely. Moreover, object recognition on point clouds is very computationally intensive and can therefore usually only be carried out at a different time than the recording and in a manner spatially separated therefrom.

For many applications, e.g., calculating the surface area for cleaning tasks, furnishing building areas and installing building systems, often all that remains currently is manual post-processing of the scanned data.

The problem addressed by embodiments of the invention consists, then, in avoiding the abovementioned disadvantages and in specifying a maximally universally usable method and a maximally universally usable apparatus for completing a 3D partial model—formed by points—of a partial region of an object that is captured by a capture device.

### SUMMARY

An aspect relates to an improved method and also an improved control device by comparison with the conventional art mentioned in the introduction.

Embodiments of the invention are directed to a method for the computer-aided completion of a 3D partial model—formed by points—of a partial region of an object that is captured by at least one capture device, wherein the 3D partial model can be supplemented with a hidden or missing partial region of the object situated outside the 3D partial model of the object that is to be completed, comprising the following steps:

a) determining a geometry of the object by comparing the 3D partial model with one or more comparable objects from a predefinable or predetermined set of objects and/or by comparing the 3D partial model with a 3D model that arose as a result of mirroring at least one part of the 3D partial model at a previously ascertained plane of symmetry or axis of symmetry,

b) identifying the hidden or missing partial region of the object on the basis of the determined geometry of the object,

c) supplementing the 3D partial model to form a complete 3D model with the identified hidden or missing partial region of the object, and

c) outputting the completed 3D model at an output unit (e.g., display).

The hidden or missing partial region of the object is that which lies outside the 3D partial model of the object that is to be completed or—to put it another way—is disjoint with respect to the partial region of the object that is represented or covered by the 3D partial model.

The 3D model or the 3D partial model can—as explained in the introduction—be formed by points (point cloud) or by meshes (mesh model).

According to embodiments of the invention, the scanned or captured part (portion) of a 3D model is supplemented by the part (portion) that is not visible from the capture device. This part (portion) is identified.

For the comparison in step a) a 3D object recognition method is carried out, which searches through a knowledge base of 3D objects for one or more comparable objects and recognizes same, wherein a set of recognized comparable objects is output as the result of the 3D object recognition method carried out.

A trained and also trainable neural network can be used for the 3D object recognition method in order to recognize a similarity between the 3D partial model and at least one object from the knowledge base.

In this regard, a selection from partial regions is possible from the identified objects and/or by way of the partial region—supplementing the mirroring mentioned—of the 3D partial model to be completed, which selection is made according to at least one predefinable quality criterion. One quality criterion may be the correspondence or difference in the number and/or density of points/meshes.

The plane of symmetry or the axis of symmetry can be ascertained by displacing the plane of symmetry or axis of symmetry as perpendicularly as possible to a reference plane, e.g. floor, of the object step by step over the surface of the 3D partial object until a comparison of partial regions of the 3D partial object on one side of the plane of symmetry or axis of symmetry with partial regions of the 3D partial object on the other side of the plane of symmetry or axis of symmetry attains a predefinable degree of correspondence. The degree of correspondence can result e.g., from the difference in the number of points or meshes, density of points or meshes, color of the points or the mesh region.

The abovementioned steps can be repeated until a predefinable quality measure, e.g., 90%, of completeness of the completed 3D model is attained.

The repetition of the procedure is expedient primarily if the partial region captured by the capture device comprises only one side of the object, since the 3D partial model can then be supplemented iteratively to form a completed 3D model by multiple mirroring at further ascertained planes of symmetry or axes of symmetry.

In this case, the quality of the representation becomes less accurate from repetition stage to repetition stage. The mirroring method offers a good compromise between quality and speed suitable for real-time applications (direct improvement of the scan during object capture).

A further aspect of embodiments of the invention provides an apparatus for the computer-aided completion of a 3D partial model—formed by points—of a partial region of an object that is captured by at least one capture device, wherein the 3D partial model can be supplemented with a hidden or missing partial region of the object situated outside the 3D partial model of the object that is to be completed, wherein the apparatus is designed to carry out the following steps:

a) determining a geometry of the object by comparing the 3D partial model with one or more comparable objects from a predefinable or predetermined set of objects and/or by comparing the 3D partial model with a 3D model that arose as a result of mirroring at least one part of the 3D partial model at a previously ascertained plane of symmetry or axis of symmetry,

b) identifying the hidden or missing partial region of the object on the basis of the determined geometry of the object,

c) supplementing the 3D partial model to form a complete 3D model with the identified hidden or missing partial region of the object, and

c) outputting the completed 3D model at an output unit.

The units or the device/apparatus configured to carry out such method steps can be implemented in terms of hardware, firmware and/or software.

A further aspect of embodiments of the invention is a computer program (product) having program code means for carrying out the method as claimed in any of the preceding method claims when it runs on a computer, apparatus or a computing unit of the type mentioned above or is stored on a computer-readable storage medium.

The computer program or a computer program product (non-transitory computer readable storage medium having instructions, which when executed by a processor, perform actions) can be stored on a computer-readable storage medium or be situated in a data stream. The computer program or computer program product can be created in a customary programming language (e.g., C++, Java). The processing device can comprise a commercially available computer or server with corresponding input, output and storage means. The processing device can be integrated in the control device or in the means thereof.

The apparatus and also the computer program (product) can be developed or embodied analogously to the abovementioned method and the developments thereof.

### BRIEF DESCRIPTION

Some of the embodiments will be described in detail, with reference to the following figures, wherein like designations denote like members, wherein:

FIG. 1A shows items as a point cloud;

FIG. 1B shows the items of FIG. 1A from a view lower than the view of FIG. 1A;

FIG. 1C shows the items of FIG. 1A from a view to the right of the view of FIG. 1A;

FIG. 1D shows the items of FIG. 1A from a view from an opposite side as the view of FIG. 1 A;

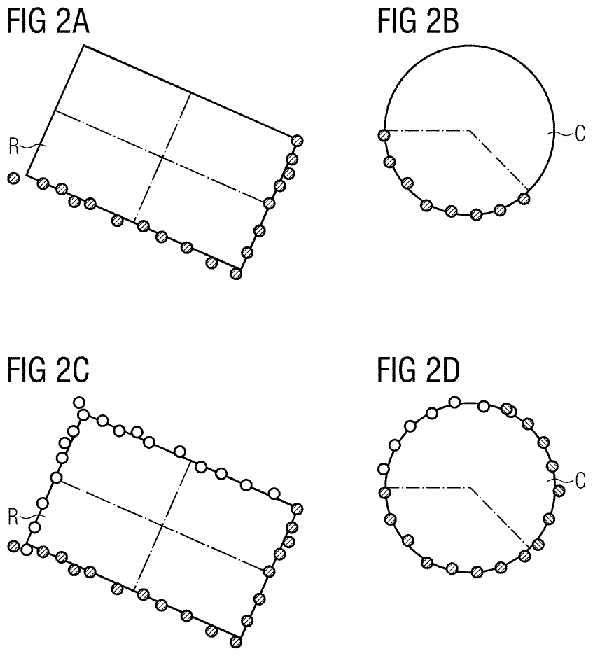

FIG. 2A schematically shows that an axis or center of symmetry can be ascertained;

FIG. 2B schematically shows that an axis or center of symmetry can be ascertained;

FIG. 2C schematically shows that an axis or center of symmetry can be ascertained;

FIG. 2D schematically shows that an axis or center of symmetry can be ascertained;

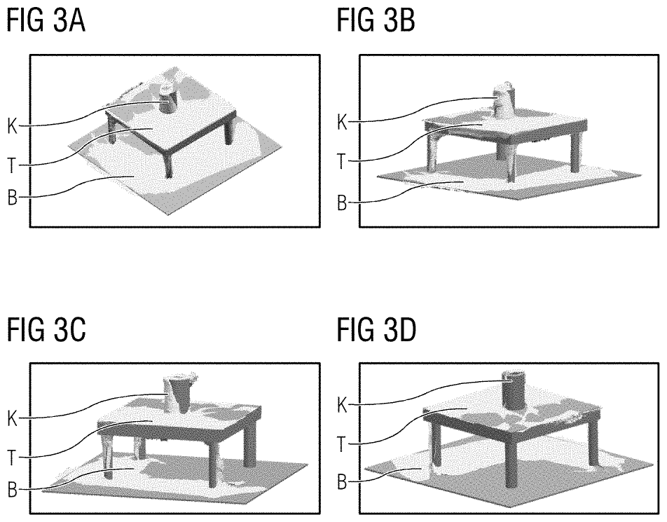

FIG. 3A schematically shows the result of the completion of the 3D partial model according to embodiments of the invention;

FIG. 3B schematically shows the result of the completion of the 3D partial model according to embodiments of the invention;

FIG. 3C schematically shows the result of the completion of the 3D partial model according to embodiments of the invention;

FIG. 3D schematically shows the result of the completion of the 3D partial model according to embodiments of the invention;

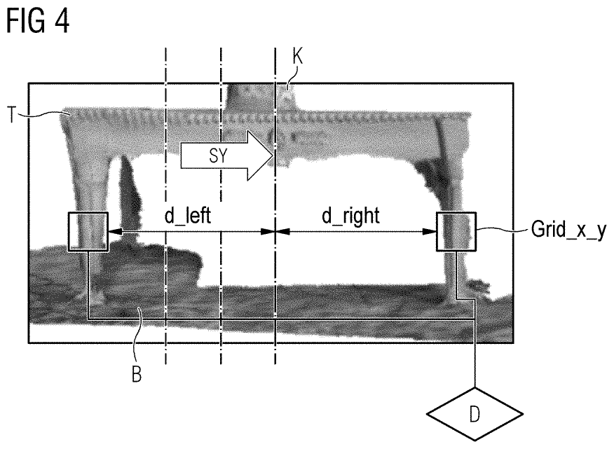

FIG. 4 schematically shows how an axis or center of symmetry can be ascertained; and

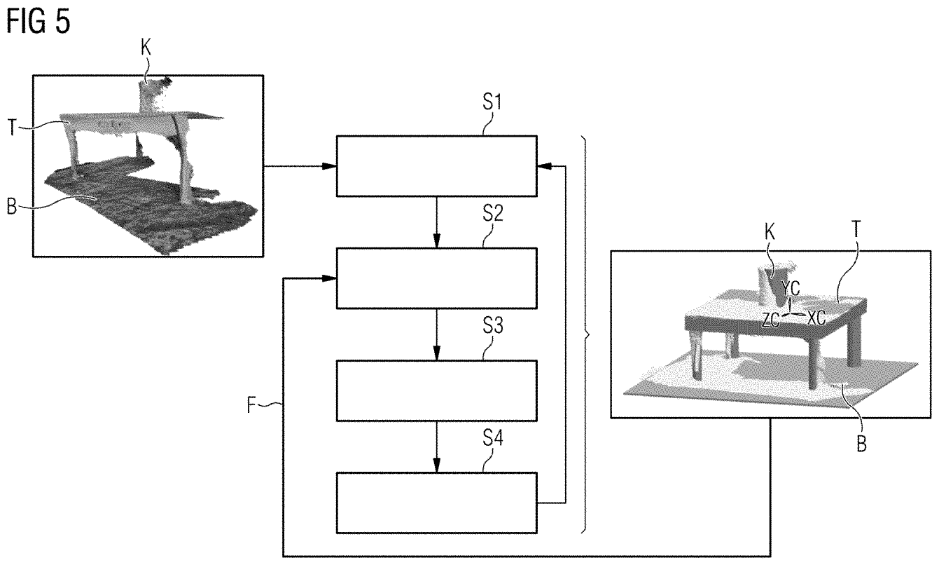

FIG. 5 schematically shows a flow diagram.

### DETAILED DESCRIPTION

FIG. 3A shows, analogously to FIG. 1A, items as a point cloud in an original view. If the completion method according to embodiments of the invention is applied, FIGS. 3B to 3D, corresponding to the views in FIGS. 1B to 1D, show that the 3D model of the objects table T and jug K is displayed completely.

FIGS. 2A to 2D schematically show that a plane of symmetry (axially symmetrical) or an axis of symmetry (rotationally symmetrical) can be ascertained. At least one plane of symmetry or axis of symmetry can often be deduced from a known surface. If, as in FIG. 2A, the object has an angular shape R, like the table, for example, then a plane of symmetry (it is assumed that the object is axially symmetrical) is sought (see FIG. 2C). If the article has a round shape C, as in FIG. 2B, then an axis of symmetry or rotation (it is assumed that the object is rotationally symmetrical) is sought (see FIG. 2D).

As indicated in FIG. 4, for example, it is firstly assumed that the plane or axis of symmetry of the surface is perpendicular to the floor B as reference plane. This applies to many articles of practical use (tables, chairs, cupboards, etc.). In addition, for its part the plane or axis of symmetry is then perpendicular to the captured surface since the geometry of most articles of practical use has right angles or rotational symmetry. Therefore, a possible plane or axis of symmetry SY can then simply be shifted over the surface in a binary search method. This is shown in FIG. 4. The quality of the plane or axis of symmetry is determined from a comparison of the points or meshes on the left and right of the plane or axis of symmetry, wherein a degree of correspondence D yields e.g., as far as possible an identical number of points or meshes, color in a grid at a specific distance on the left/right of the plane or axis of symmetry, density of the points or meshes, etc.

FIG. 5 shows a flow diagram, in the context of which the method according to embodiments of the invention can be embedded. The method can be used in real-time applications, that is to say that a direct improvement of the scan is attained during capture or recording. The method can be carried out on apparatuses such as e.g., edge devices, camera circuit boards, etc.

FIG. 5 shows on the left the incomplete 3D model or the 3D partial model of an object, in the example the table T with the jug K. The completed 3D (partial) model is shown on the right in FIG. 5. The following steps can be carried out:

In step S1, an object recognition method can be used. A comparison or correlation of the point cloud or of the mesh model with a knowledge base of possible 3D objects of the desired scene is used for this purpose. The intention is thus to determine the geometry (in the example angular table and/or round jug) or shape of the object. The hidden or missing partial region of the object can be identified on the basis of the determined geometry of the object. The 3D partial model can then be supplemented with (partial) regions of the recognized object which correspond to the identified hidden or missing partial regions to form a completed 3D model.

This is done substantially by attempting to minimize the distance or difference D of the points or the meshes from a 3D model of a known object originating from a predefinable or predetermined set of objects, for example from the knowledge base. If a hit is thereby attained, then the correspondingly recognized object can be connected to the existing points/meshes such that the entire surface of the 3D model can be described either by the points of the point cloud, or meshes of the mesh model, or by partial areas of the recognized or identified object (genuine data of the point cloud having priority).

In step 2, a trained or trainable neural network in an AI module (AI: artificial intelligence) can be used if the previous comparison was not successful or was only partly successful. The missing partial region of the 3D partial model can then be supplemented with the aid of objects or partial objects proposed by the AI module, provided that the proposed objects have a predefinable degree of similarity, e.g., 95%. It is possible for AI methods to be trained with the data or feedback of other/all users, this being designated by F in FIG. 5. In other words, an object is scanned or captured from a plurality of sides (a plurality of surfaces). In this regard, each side can serve as an input for a neural network, which then outputs the remaining surfaces as output. If this training is repeated with enough user data (which have seen the object from different sides or views in each case), then the network can finally reconstruct the remaining surfaces given the input of at least one surface. The knowledge base can be supplemented or completed with the aid of the neural network. For articles that can be described formally, so-called generative adversarial networks (GANs) could also be used. In this case, the results output by a first neural network are then rated by a further neural network that has been trained (e.g., on the basis of specific rules) to rate the quality of the result of the first network.

An aspect of the method according to embodiments of the invention is manifested in step S3. By way of example, if the two steps above were not successful or one or more partial regions of the 3D (partial) model are still missing or hidden (e.g., on account of missing knowledge base data or training data), then for many applications it is possible to carry out at least one surface reconstruction on the basis of the identified hidden or missing partial regions on the basis of a geometry to be determined. The geometry may optionally already be known from step S1 and/or S2 or results from the following mirroring method. One or more planes or axes of symmetry—as described with regard to FIGS. 2A to 2D and FIG. 4—are ascertained. The 3D partial model is supplemented to form a complete 3D model by the mirroring of at least one part of the 3D partial model at the ascertained plane/axis of symmetry. Ultimately, as shown in FIGS. 3A to 3D, the completed 3D model can be output or displayed at an output unit, e.g., a display. The method improves not only the visual appearance of the 3D model, but also its meaningfulness for measurements (such as e.g., estimation of surface areas to be cleaned or of structural or furnishing space still available).

In step S4, optionally the 3D model can be closed in a simple manner with the fewest possible planes/axes of symmetry if the preceding steps were not successful or were only partly successful.

Steps S1 to S4 can also be repeated until a predefinable quality measure, e.g., 90%, of completeness of the completed 3D model is attained. The repetition of steps S1 to S4 is expedient primarily if the scanned or captured partial region comprises only one side of the object. In this case, the 3D partial model can be iteratively supplemented to form a completed 3D model by multiple mirroring at further ascertained planes or axes of symmetry.

Although the invention has been more specifically illustrated and described in detail by the exemplary embodiments, nevertheless the invention is not restricted by the examples disclosed and other variations can be derived therefrom by the person skilled in the art, without departing from the scope of protection of the invention.

The above-described processes or method sequences/steps can be implemented on the basis of instructions present on computer-readable storage media or in volatile computer storage units (referred to hereinafter in combination as computer-readable storage units). Computer-readable storage units are for example volatile storage units such as caches, buffers or RAM and also nonvolatile storage units such as exchangeable data carriers, hard disks, etc.

In this case, the above-described functions or steps can be present in the form of at least one instruction set in/on a computer-readable storage unit. In this case, the functions or steps are not tied to a specific instruction set or to a specific form of instruction sets or to a specific storage medium or to a specific processor or to specific execution schemes and can be executed by software, firmware, microcode, hardware, processors, integrated circuits, etc., in standalone operation or in any desired combination. In this case, a wide variety of processing strategies can be used, for example serial processing by a single processor or multiprocessing or multitasking or parallel processing, etc.

The instructions can be stored in local storage units, but it is also possible to store the instructions on a remote system and to access them via a network.

In association with embodiments of the invention, “computer-aided” can be understood to mean for example a computer implementation of the method in which in particular a processor, which can be part of the control/computing apparatus or unit, carries out at least one method step of the method.

The term “processor”, “central signal processing”, “control unit” or “data evaluation means”, as used here, encompasses processing means in the broadest sense, that is to say for example servers, universal processors, graphics processors, digital signal processors, application-specific integrated circuits (ASICs), programmable logic circuits such as FPGAs, discrete analog or digital circuits and any desired combinations thereof, including all other processing means that are known to the person skilled in the art or will be developed in the future. In this case, processors can consist of one or more apparatuses or devices or units. If a processors consists of a plurality of apparatuses, the latter can be designed or configured for parallel or sequential processing or execution of instructions. In association with embodiments of the invention, a “storage unit” can be understood to mean for example a memory in the form of random-access memory (RAM) or a hard disk.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A method for the computer-aided completion of a 3D partial model—formed by points—of a partial region of an object that is captured by at least one capture device, wherein the 3D partial model can be supplemented with a hidden or missing partial region of the object situated outside the 3D partial model of the object that is to be completed, comprising:
a) determining a geometry of the object by comparing the 3D partial model with one or more comparable 3D objects from a predefinable or predetermined set of objects and/or by comparing the 3D partial model with a 3D model that arose as a result of mirroring at least one part of the 3D partial model at a previously ascertained plane of symmetry or axis of symmetry;
b) identifying the hidden or missing partial region of the object on the basis of the determined geometry of the object;
c) supplementing the 3D partial model to form a complete 3D model with the identified hidden or missing partial region of the object; and
c) outputting the completed 3D model at an output unit.

2. The method as claimed in claim 1, wherein for the comparison in a) a 3D object recognition method is carried out, which searches through a knowledge base of 3D objects for one or more comparable objects and recognizes same, wherein a set of recognized comparable objects is output as the result of the 3D object recognition.

3. The method as claimed in claim 2, wherein a trained and also trainable neural network is used for the 3D object recognition method in order to recognize a similarity between the 3D partial model and at least one 3D object from the knowledge base.

4. The method as claimed in claim 1, wherein the plane of symmetry or the axis of symmetry is ascertained by displacing the plane of symmetry or axis of symmetry as perpendicularly as possible to a reference plane of the object step by step over the surface of the 3D partial object until a comparison of partial regions of the 3D partial object on one side of the plane of symmetry or axis of symmetry with partial regions of the 3D partial object on the other side of the plane of symmetry or axis of symmetry attains a predefinable degree of correspondence.

5. The method as claimed in claim 1, wherein the method is repeated until a predefinable quality measure of completeness of the completed 3D model is attained.

6. An apparatus for the computer-aided completion of a 3D partial model formed by points of a partial region of an object that is captured by at least one capture device, wherein the 3D partial model can be supplemented with a hidden or missing partial region of the object situated outside the 3D partial model of the object that is to be completed, wherein the apparatus is configured for:
a) determining a geometry of the object by comparing the 3D partial model with one or more comparable 3D objects from a predefinable or predetermined set of objects and/or by comparing the 3D partial model with a 3D model that arose as a result of mirroring at least one part of the 3D partial model at a previously ascertained plane of symmetry or axis of symmetry;
b) identifying the hidden or missing partial region of the object on the basis of the determined geometry of the object;
c) supplementing the 3D partial model to form a complete 3D model with the identified hidden or missing partial region of the object; and
c) outputting the completed 3D model at an output unit.

7. The apparatus as claimed in claim 6, wherein the apparatus is configured to carry out a 3D object recognition method for the comparison in a), wherein the 3D object recognition method searches through a knowledge base of 3D objects for one or more comparable objects and recognizes same, wherein a set of recognized comparable objects is output as the result of the 3D object recognition method.

8. The apparatus as claimed in claim 6, wherein the apparatus is configured to use a trained and also trainable neural network for the 3D object recognition method in order to recognize a similarity between the 3D partial model and at least one 3D object from the knowledge base.

9. The apparatus as claimed in claim 6, wherein the apparatus is configured to ascertain the plane of symmetry or the axis of symmetry by displacing the plane of symmetry or axis of symmetry as perpendicularly as possible to a reference plane of the object step by step over the surface of the 3D partial object until a comparison of partial regions of the 3D partial object on one side of the plane of symmetry or axis of symmetry with partial regions of the 3D partial object on the other side of the plane of symmetry or axis of symmetry attains a predefinable degree of correspondence.

10. The apparatus as claimed in claim 6, wherein the apparatus is configured to repeat steps until a predefinable quality measure of completeness of the completed 3D model is attained.

11. A computer program product, comprising a computer readable hardware storage device having computer readable program code stored therein, said program code executable by a processor of a computer system to implement the method as claimed in claim 1.

12. A computer-readable storage or data transmission medium, comprising instructions which, when executed by a computer, cause the latter to carry out the method as claimed in claim 1.
